(19) United States
(12) Patent Application Publication
(10) Pub. No.: US 2006/0013260 A1
(43) Pub. Date: Jan. 19, 2006

(54) Optical line termination system, method and apparatus for bus management, and method and apparatus for signal concentration

(75) Inventor: Moshe Oron, San Rafael, CA (US)

Correspondence Address: PILLSBURY WINTHROP SHAW PITTMAN LLP, P.O. BOX 10500, MCLEAN, VA, 22102, US

(73) Assignee: ADVANCED FIBRE COMMUNICATIONS, INC.

(21) Appl. No.: 10/880,234

(22) Filed: Jun. 28, 2004

(51) Int. Cl. H04J 3/00

(52) U.S. Cl. 370/498

(57) ABSTRACT

A method of communications processing according to an embodiment of the invention includes receiving idle traffic via each of a plurality of voice ports. The method also includes receiving active traffic via at least one of the plurality of voice ports, while continuing to receive idle traffic via the remainder of the plurality of voice ports, and concentrating the active traffic received via at least one of the plurality of voice ports onto a shared bus.

### FIELD OF THE INVENTION

The invention relates to communications networks.

### BACKGROUND

The following acronyms may appear in the description below: APON, asynchronous transfer mode (ATM) passive optical network (PON); ASIC, application-specific integrated circuit; ATM, asynchronous transfer mode; B-PON or BPON (broadband PON); CATV, community access television (cable television); CPU, central processing unit (e.g. microprocessor); EPON (Ethernet PON); FPGA, field-programmable gate array; ISDN, integrated services digital network; PON, passive optical network; POTS, plain old telephone service; PPV, pay per view; PSTN, public switched telephone network; RAM, random-access memory; ROM, read-only memory; TDM, time division multiplexed (or multiplexing); VoIP, voice over Internet Protocol; VoATM, voice over ATM; VoD, video on demand.

Optical access systems offer a potentially large bandwidth as compared to copper-based access systems. A broadband optical access system may be used, for example, to distribute a variety of broadband and narrowband communication services from a service provider's facility to a local distribution point and/or directly to the customer premises. These communication services may include telephone (e.g. POTS, VoIP, VoATM), data (e.g. ISDN, Ethernet), and/or video/audio (e.g. television, CATY, PPV, VoD) services.

FIG. 1 shows examples of two optical access network (OAN) architectures. The first example includes an optical line termination (OLT), an optical distribution network (ODN), an optical network unit (ONU), and a network termination (NT). The OLT provides the network-side interface of the OAN (e.g. a service node interface or SNI), and it may be located at a carrier's central office or connected to a central office via a fibre trunk (e.g. the OLT may include an OC-3/STM-1 or OC-12c/STM-4c interface).

The OLT may be implemented as a stand-alone unit or as a card in a backplane. The AccessMAX OLT card of Advanced Fibre Communications (Petaluma, Calif.) is one example of a superior OLT product. Other examples of OLTs include the 7340 line of OLTs of Alcatel (Paris, France), the FiberDrive OLT of Optical Solutions (Minneapolis, Minn.), and assemblies including the TK3721 EPON media access controller device of Teknovus, Inc. (Petaluma, Calif.). The OLT may communicate (e.g. via cable, bus, and/or data communications network (DCN)) with a management system or management entity, such as a network element operations system (NE-OpS), that manages the network and equipment.

On the user side, the OLT may be connected to one or more ODNs. An ODN provides one or more optical paths between an OLT and one or more ONUs. The ODN provides these paths over one or more optical fibres. The ODN may also include optional protection fibres (e.g. for backup in case of a break in a primary path).

An optical network unit (ONU) is connected to an ODN and provides (either directly or remotely) a user-side interface of the OAN. The ONU, which may serve as a subscriber terminal, may be located outside (e.g. on a utility pole) or inside a building. One or more network terminations (NTs) are connected to an ONU (e.g. via copper trace, wire, and/or cable) to provide user network interfaces (UNIs), e.g. for services such as Ethernet, video, and ATM. Implementations of such an architecture include arrangements commonly termed Fibre to the Building (FTTB), Fibre to the Curb (FTTC), and Fibre to the Cabinet (FTTCab).

The second architecture example in FIG. 1 includes an OLT, an ODN, and one or more optical network terminations (ONTs). An ONT is an implementation of an ONU that includes a user port function. The ONT serves to decouple the access network delivery mechanism from the distribution at the customer premises (e.g. a single-family house or a multi-dwelling unit or business establishment). Implementations of such an architecture include arrangements commonly termed Fibre to the Home (FTTH). In some applications, an ONT may be wall-mounted.

The AccessMAX ONT 610 of Advanced Fibre Communications (Petaluma, Calif.) is one example of a superior ONT product. Other examples of ONTs include the Exxtenz ONT of Carrier Access Corporation (Boulder, Colo.), the FiberPath 400 and 500 lines of ONTs of Optical Solutions, the 7340 line of ONTs of Alcatel, and assemblies including the TK3701 device of Teknovus, Inc.

As shown in FIG. 1, an OAN (including an ODU and the terminals connected to it) may be configured in several different ways, and two or more OANs may be connected to the same OLT. As shown in FIG. 2, an ODN may connect an OLT to multiple ONUs. An ODN may also be connected to both ONUs and ONTs. In some applications, the nominal bit rate of the OLT-to-ONU signal may be selected from the rates 155.52 Mbit/s and 622.08 Mbit/s, although other rates are also possible for upstream and downstream communications.

An ODN that contains only passive components (e.g. fibre and optical splitters and/or combiners) may also be referred to as a passive optical network (PON). Depending e.g. on the particular protocol used, a PON may also be referred to, for example, as a B-PON (broadband PON), EPON (Ethernet PON), or APON (ATM PON). A OAN may include different OLTs and/or ONUs to handle different types of services (e.g. data transport, telephony, video), and/or a single OLT or ONU may handle more than one type of service. The OLT and/or one or more of the ONUs may be provided with battery backup (e.g. an uninterruptible power supply (UPS)) in case of mains power failure.

FIG. 3 shows an example of a OLT connected to a PON that includes a four-way splitter 20 and four eight-way splitters 30a-d. In this example, each of up to thirty-two ONUs may be connected to the PON via a different output port of splitters 30a-d (where the small circles represent the PON nodes depending from these ports). Other PON configurations may include different splitter arrangements. In some such configurations, for example, a path between the OLT and one ONU may pass through a different number of splitters than a path between the OLT and another ONU.

The protocol for communications between the OLT and the ONUs may be ATM-based (e.g. such that the OLT and ONUs provide transparent ATM transport service between the SNI and the UNIs over the PON), for example. Such embodiments of the invention may be applied to optical access systems that comply with one or more of ITU-T Recommendation G.983.1 (“Broadband optical access systems based on Passive Optical Networks (PON),” dated October 1998 and as corrected July 1999 and March 2002 and amended November 2001 and March 2003, along with Implementor's Guide of October 2003) (International Telecommunication Union, Geneva, CH), and ITU-T Recommendation G.983.2 (“ONT management and control interface [OMCI] specification for B-PON,” dated June 2002 and as amended March 2003, along with Implementor's Guide of April 2000) (International Telecommunication Union, Geneva, CH). Additional aspects of optical access systems to which embodiments of the invention may be applied are described in the aforementioned Recommendations.

An OLT may be capable of delivering one or multiple voice telephony lines to each of a subset of subscribers (possibly to each subscriber) via one or more respective ONTs. FIG. 4A shows an architecture example including an OLT with an integrated voice gateway, an ODN, and an ONT. The OLT is connected to an external ATM network and an external PSTN. This example illustrates a dichotomy between packet switched (e.g., ATM data) signals and circuit switched (e.g., PSTN voice) signals. ATM packet switched signals may typically be passed between the external ATM network and the PON without any encapsulation operation, for both networks employ ATM protocols. In contrast, circuit switched voice signals, which may be modulated by the PSTN in accordance with synchronous (e.g. TDM) protocols, may need to be encapsulated over ATM for transmission within the PON. In the PON, the voice signals are carried as packets of ATM cells and transported over a high bandwidth physical medium. Bandwidth for voice transport may be over-engineered (e.g. to reduce voice delay within the PON), and ATM cells that carry voice signals may be only partially filled (e.g. to reduce packetization delay). Outgoing ATM voice signals from the PON are decapsulated into TDM voice signals for transmission over the PSTN.

In a TDM “nailed-up” transport approach, the OLT locally decapsulates ATM voice signals to TDM voice signals onto a TDM voice infrastructure that reserves capacity for every subscriber line of the PON. Because transport resources are provided for all possible subscribers, such an approach may be very inefficient in practice. Though OLT systems may have a very high capacity and density of served subscriber lines, in practice subscribers seldom need to concurrently utilize every available voice line.

In an ATM transport approach, ATM voice signals are transported through an OLT to an interface (e.g., a gateway external to the OLT), which terminates the packetized voice signals and decapsulates them into TDM voice signals onto the switch interface to the PSTN. However, if partial cell fill is used for circuit emulation, ATM transport facilities at the OLT must support a much higher bandwidth, even more so as they carry voice traffic for multiple PON networks. In addition, the ATM transport facilities may need to transport all circuits—whether active or not—or, alternatively, address the complexity of dynamically setting virtual circuit connections (VCCs) upon call activity. Switched virtual circuits (SVCs) may be employed to accomplish dynamic allocation, but these require implementation of a complex signaling stack. Such additional complexity increases software development costs and requires processing hardware and ATM switching hardware capable of setting up calls quickly enough to meet stringent timing requirements. Other methods for concentrating voice traffic over. ATM cells (e.g. AAL2 idle channel suppression) also involve higher complexity.

### SUMMARY

A method of communications processing according to an embodiment of the invention includes receiving idle traffic via each of a plurality of voice ports. The method also includes receiving active traffic via at least one of the plurality of voice ports, while continuing to receive idle traffic via the remainder of the plurality of voice ports, and concentrating the active traffic received via at least one of the plurality of voice ports onto a shared bus.

A method of communications processing according to another embodiment of the invention includes receiving active traffic via each of a first voice port and a second voice port, and receiving a first allocation of resources of a shared bus and a second allocation of resources of the shared bus. The method also includes concentrating the active traffic received via the first voice port onto the shared bus according to the first allocation, and concentrating the active traffic received via the second voice port onto the shared bus according to the second allocation. At least one of the group consisting of the active traffic received via the first voice port and the active traffic received via the second voice port consists essentially of partially filled cells.

A communications apparatus according to an embodiment of the invention includes a shared bus and a cross-connect device. The cross-connect device is configured to receive idle traffic via each of a plurality of voice ports and to transfer, onto an allocated portion of the shared bus, a voice signal based on active traffic received via one of the plurality of voice ports.

A communications apparatus according to another embodiment of the invention includes a shared bus and a cross-connect device. The cross-connect device is configured to receive active traffic via each of a first voice port and a second voice port and to transfer, onto a first allocated portion of the shared bus, a voice signal based on active traffic received via the first voice port. The cross-connect device is also configured to transfer, onto a second allocated portion of the shared bus different from the first allocated portion, a voice signal based on active traffic received via the second voice port, At least one of the group consisting of the active traffic received via the first voice port and the active traffic received via the second voice port consists essentially of partially filled cells.

### BRIEF DESCRIPTION OF THE DRAWINGS

FIG. 1 shows examples of two OAN architectures.

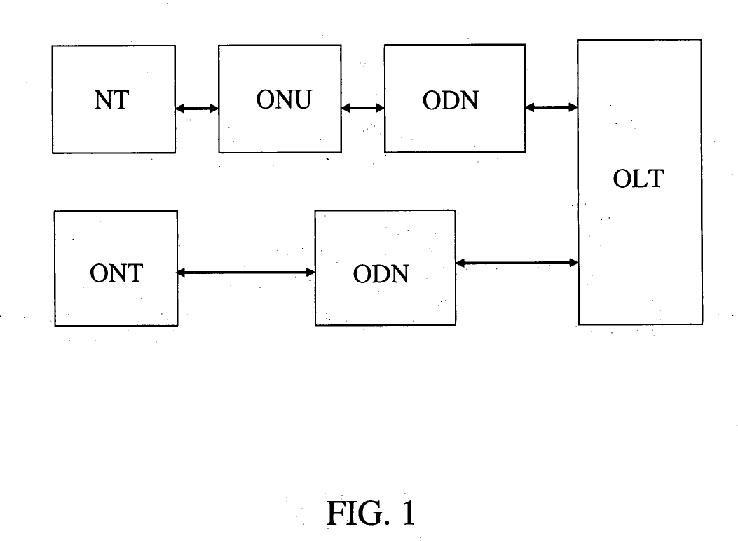

FIG. 2 shows an example of an OAN.

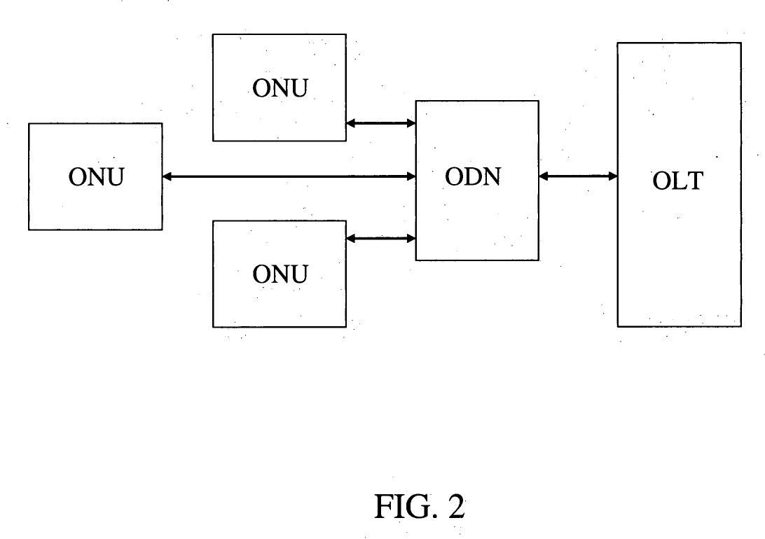

FIG. 3 shows an example of an OLT and a PON including splitters.

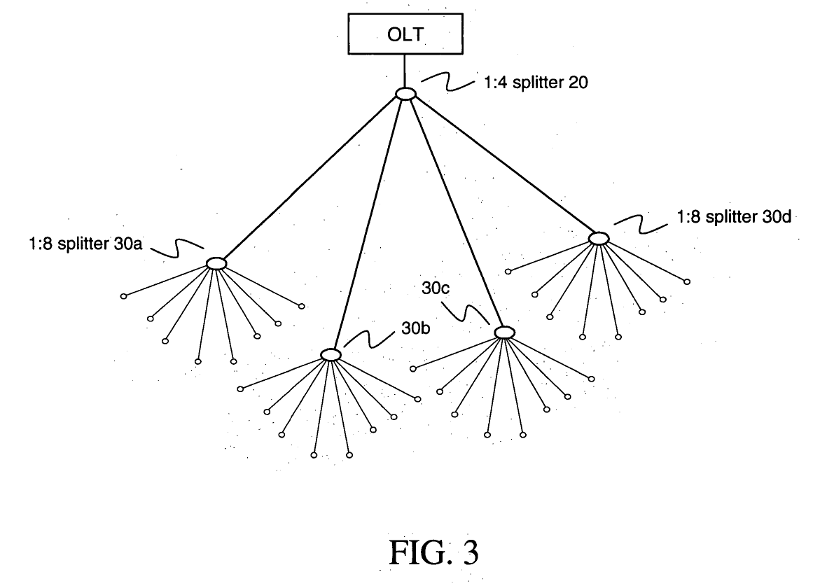

FIG. 4A shows an example of an OAN architecture.

FIG. 4B shows an example of an OLT system with an integrated voice gateway.

FIG. 5 shows a flowchart of a method according to an embodiment of the invention.

FIG. 6A shows a flowchart of a method according to an embodiment of the invention.

FIG. 6B shows a flowchart of a method according to an embodiment of the invention.

FIG. 6C shows a flowchart of a method according to an embodiment of the invention.

FIG. 7 shows a system according to an embodiment of the invention.

FIG. 8 shows a controller according to an embodiment of the invention.

FIG. 9 shows an interface according to an embodiment of the invention.

FIG. 10 shows a system according to an embodiment of the invention.

FIG. 11 shows an architecture for concentrating ATM signals onto a TDM bus according to an embodiment of the invention.

FIG. 12 shows a system according to an embodiment of the invention.

FIG. 13 shows interactions between a subscriber line card, control card, and switch interface card according to an embodiment of the invention.

FIG. 14 shows an implementation of a switch interface according to an embodiment of the invention.

FIG. 15 shows an implementation of a subscriber interface according to an embodiment of the invention.

FIG. 16 shows a system according to an embodiment of the invention.

FIG. 17 shows a system including a data storage medium according to an embodiment of the invention.

### DETAILED DESCRIPTION

In general, OAN systems employ asynchronous transfer mode (ATM) based protocols for voice calls, while external circuit-switched telephone networks (e.g., PSTNs—public switched telephone networks) employ time division multiplexing (TDM) based protocols. Accordingly, for voice calls spanning both OAN systems and circuit-switched networks, adaptation between the protocols may be necessary, whether within an OLT system or at a location between the OLT system and the circuit-switched network.

Embodiments of the invention provide methods and systems for facilitating such adaptation for voice calls in a highly efficient, practical, and cost-effective manner that may also be applied to achieve high voice quality. Embodiments herein may be useful, for example, to architects, service providers, and other operators of a passive optical network (PON).

According to embodiments of the invention, a common TDM bus is shared between a subscriber interface (e.g., a PON-side interface) and a switch interface (e.g., a PSTN-side interface). The bus may be shared among multiple subscribers (e.g. via subscriber interface line cards), associated with one or more different PONs, and/or among multiple voice switch interface line cards associated with a PSTN. The bus may transport only active calls, and resources otherwise needed for ATM transport may be eliminated. As such, voice capacity aggregated from multiple PONs can be efficiently concentrated. It is estimated that in some cases, the aggregated voice capacity may be statistically reduced by a factor of ten.

In various embodiments of the invention, high bandwidth on a PON (including partial cell fill and/or transport of traffic for inactive calls) may be employed to achieve high quality for voice calls transported over ATM in the PON without the need to introduce complex bandwidth allocation methodologies. Calls to be carried between the PON and an external TDM-based network are concentrated so that only active calls are transported over a shared TDM bus. Such an approach maximizes bandwidth savings, especially in systems that aggregate multiple PONs and thousands of subscribers.

In an embodiment of the invention, a central control module (e.g. a control card) allocates resources on a shared TDM bus. The central control module may be provisioned with the logical mappings from ONT voice ports to OLT voice interface card ports (for example, to enable or facilitate routing of calls to appropriate locations, such as the ONT associated with a particular voice circuit). The subscriber interface line cards decapsulate packetized ATM voice signals onto TDM (e.g., PCM—pulse code modulation) voice signals. Each subscriber interface line card and switch interface line card may enable programmable access to the TDM bus via a programmable TDM cross-connect device. The TDM cross-connect device cross-connects any arbitrary PON side channel to any arbitrary TDM bus channel.

Embodiments herein may complement and coexist with techniques applied in PONs to reduce delays in ATM voice traffic, such as bandwidth over-engineering techniques. Embodiments herein may also'avoid shortcomings of other approaches taken to adapt voice traffic between an asynchronous system (e.g., an ATM-based system) and a synchronous system (e.g., a ITDM-based system).

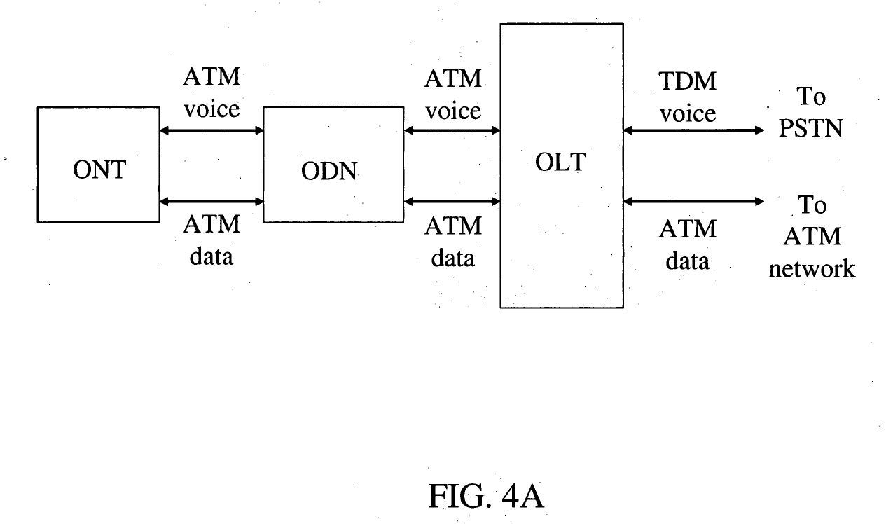

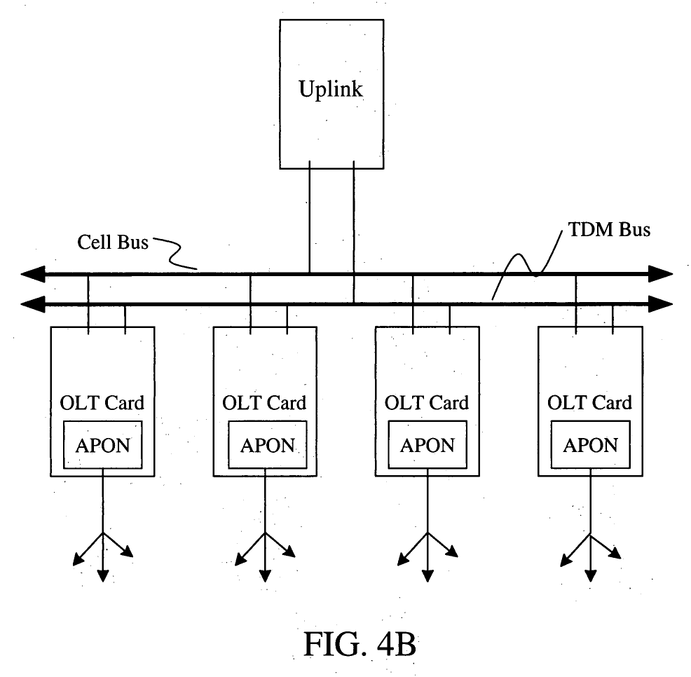

FIG. 4B shows an example of an OLT system. The OLT system includes one or more OLTs (e.g. cards) in communication with an uplink (e.g. a switch interface) to one or more external systems (e.g., ATM-based and TDM-based systems) via a cell (e.g., ATM cell) bus and/or a TDM bus. Each OLT may serve one or more PONs. The number of OLT cards shown in FIG. 4A is exemplary. The system includes an integrated voice gateway that serves as an ATM termination and a PSTN interface.

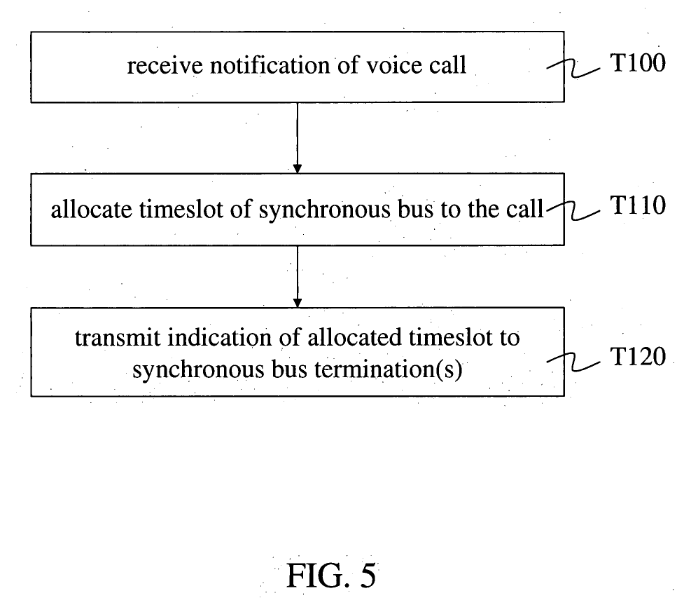

FIG. 5 shows a flowchart of a method according to an embodiment of the invention. The method may be performed by, for instance, a control module in an OLT or related entity, which module controls the allocation of resources of a shared synchronous (e.g., TDM-based) bus. Task T100 receives a notification of a voice call that is to be carried between an asynchronous network (e.g. the PON) and a synchronous network (e.g. the circuit-switched network). For instance, the voice call may have originated from a port of an ONU (e.g., an ONT—optical network termination), with its destination being a subscriber line of a circuit-switched network (e.g., an external PSTN). In this case, the notification may be received, for example, from a TDM cross-connect device with signaling monitoring (e.g. via an OAM channel). Alternatively, the voice call may have originated at a subscriber line of a circuit-switched network, with its destination being a port of an ONU.

Task T110 allocates a timeslot of the synchronous bus to the call. In particular, task T110 may assign one or more available synchronous bus timeslots to the call. Task T120 transmits an indication of the allocated bus timeslot to one or both of the synchronous bus terminations associated with the call (e.g. via an OAM channel). (In an embodiment, the transmitting of the indication may be referred to as signaling.) The indication may specify which bus resources should be used at each end of the synchronous bus. The synchronous bus terminations may be respectively associated with, for instance, a subscriber interface and a switch interface.

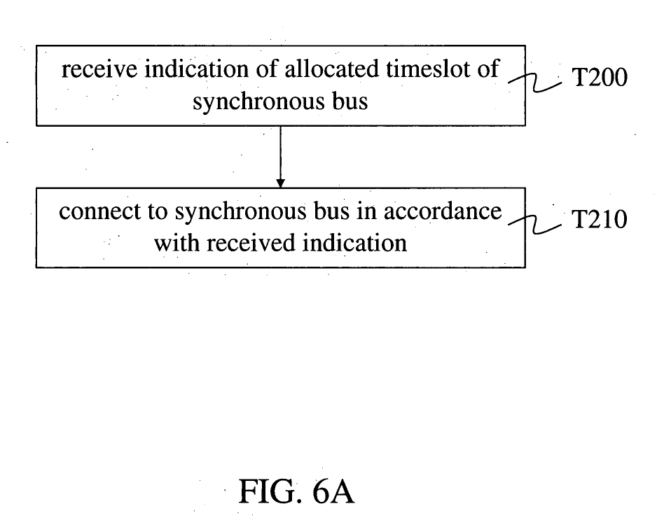

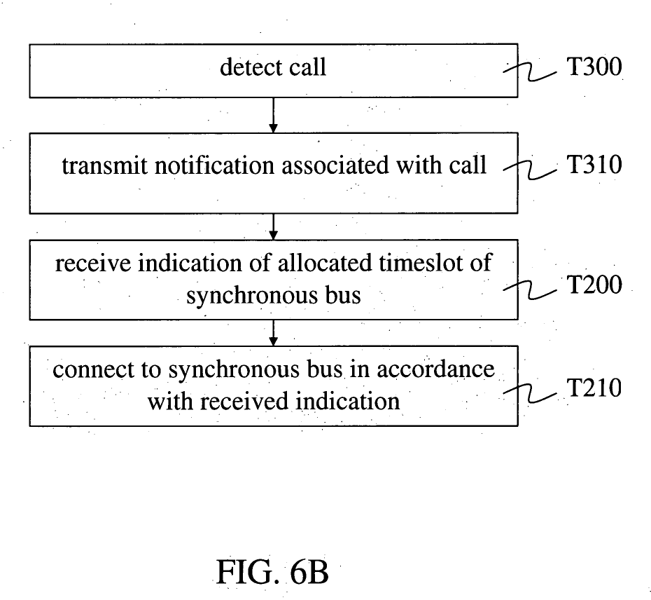

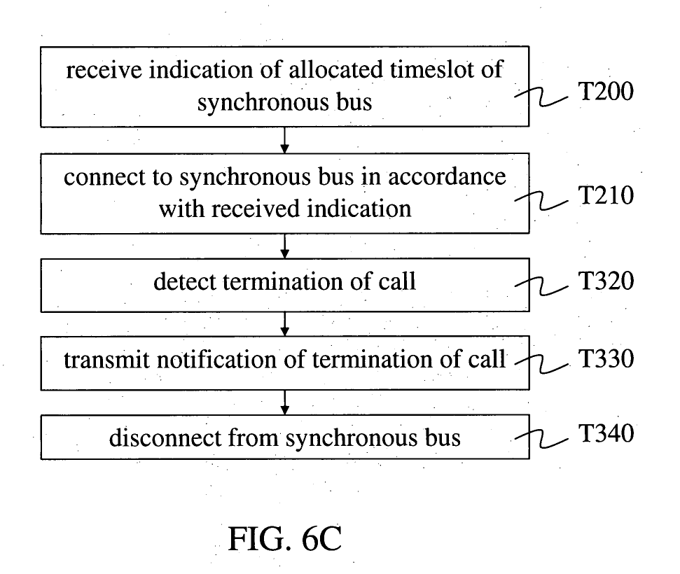

FIG. 6A shows a flowchart of a method of call setup according to another embodiment of the invention. The method, which is a counterpart to that shown in FIG. 5, may be performed by a synchronous bus termination in, for example, a subscriber line interface card (to a PON), such as a programmable TDM cross-connect device. Alternatively, the method may be performed by a switch interface line card (associated with the PSTN). Task T200 receives an indication of an allocated timeslot of the synchronous bus (e.g. via an OAM channel). The indication may come, for example, from a control module (e.g. a control card) in an OLT. Task T210 connects (e.g. a port of the cross-connect device) to the synchronous bus in accordance with the received indication. Accordingly, the termination may be configured according to the allocated synchronous bus resources so that the call may be established. It is to be understood that, in some embodiments, the method of FIG. 6A may be performed with respect to both synchronous bus terminations associated with the call, such that each termination is configured to connect to the synchronous bus according to a respective received indication.

FIG. 6B shows a flowchart of a method of call detection and setup according to an embodiment of the invention. The method, which is another counterpart to that shown in FIG. 5, may be performed by a synchronous bus termination in, for example, a subscriber line interface card (to a PON), such as a programmable TDM cross-connect device. Alternatively, the method may be performed by a switch interface line card (associated with the PSTN). Task T300 detects a call. Task T310 transmits a notification associated with the call. For example, task T310 may transmit a notification to a control module in an OLT, which may then allocate a timeslot of the synchronous bus to the call. Task T200 receives an indication of the allocated timeslot of the synchronous bus. Task T210 connects (e.g. a port of the cross-connect device) to the synchronous bus in accordance with the received indication.

FIG. 6C shows a flowchart of a method of call setup and teardown according to an embodiment of the invention. The method, which is a further counterpart to that shown in FIG. 5, may be performed by a synchronous bus termination in, for example, a subscriber line interface card (to a PON), such as a programmable TDM cross-connect device. Alternatively, the method may be performed by a switch interface line card (associated with the PSTN). Task T200 receives an indication of an allocated timeslot of a synchronous bus (e.g. via an OAM channel). The indication may come, for example, from a control module (e.g. a control card) in an OLT. Task T210 connects to the synchronous bus in accordance with the received indication. Task T320 detects a termination of the call. Task T330 transmits a notification of the termination of the call, such as to a control module in an OLT (e.g. via an OAM channel). Task T340 disconnects from the synchronous bus. In some embodiments, task T340 may disconnect from the synchronous bus in response to a signal received from a control or other module (e.g. via an OAM channel). In other embodiments, task T340 may disconnect from the synchronous bus after a predetermined time period beginning with termination of the call.

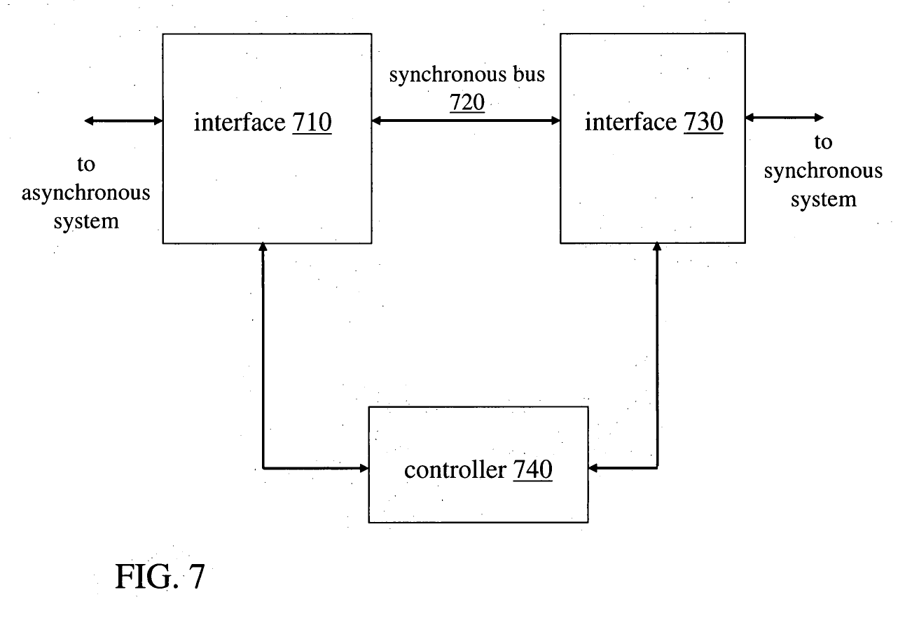

FIG. 7 shows a system according to an embodiment of the invention. The system includes an interface 710, an interface 730, and a controller 740.

Interface 710 is an interface between an asynchronous (e.g., ATM-based) system and a synchronous (e.g., TDM-based) bus 720. For example, interface 710 may be included in a subscriber line interface (e.g. a card providing an interface to a PON). Interface 730 is an interface between a shared synchronous bus 720 and a synchronous (e.g., TDM-based) network. For example, interface 730 may be included in a switch interface (e.g. a card or other module providing an interface to the PSTN). Controller 740 (e.g. a control card) allocates resources of synchronous bus 720. Interfaces 710 and 730 connect to shared synchronous bus 720 to use the resources allocated by controller 740.

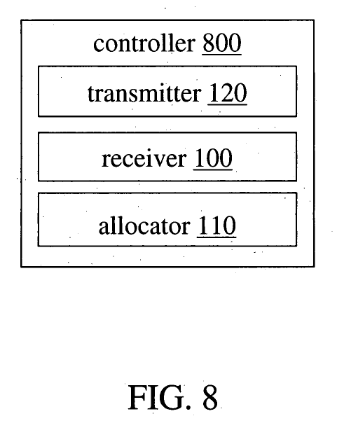

FIG. 8 shows a controller 800 according to an embodiment of the invention. Controller 800 may be employed, for example, in an OLT system to direct usage of a shared TDM bus for voice calls. In this example, controller 800 includes a receiver 100, an allocator 110, and a transmitter 120.

Receiver 100 receives (e.g. over a circuit trace or control bus) an indication of a voice call to be carried between a PON and a circuit switched network (e.g. a call setup request). Receiver 100 may also receive other call information such as an indication of the origination and/or desired destination for the call (e.g. an originating circuit number, which may be associated with an ONT port). Allocator 110 allocates, to the call, at least one time slot of a shared TDM bus associated with the PON (and possibly with other PONs). Allocator 110 may also identify (e.g. via a port-to-port mapping as described herein, possibly stored in nonvolatile memory such as flash) an appropriate synchronous bus termination to receive the call. Allocator 100 may include an array of logic elements (e.g. an application-specific integrated circuit or programmable device). Transmitter 120 transmits (e.g. over a circuit trace or control bus) an indication of the allocated timeslot to one or both synchronous bus terminations associated with the call.

Controller 800 may be a part of a PON card, management system device, and/or control card internal or external to an OLT. In some embodiments, such a device may be inserted into a backplane of an OLT, and the OLT may include other cards or card assemblies inserted into the same or a different backplane. Such a backplane may include a standardized bus (e.g. ISA, PCI, VME, VxI) and/or a proprietary or otherwise non-standardized bus. For example, the backplane may include a control bus over which controller 800 communicates with interfaces to a shared synchronous bus (e.g. via OAM channels). Alternatively, the management system or entity may be external to the OLT and associated equipment and may also include, for example, a command-line interface (CLI) or operational support system (OSS).

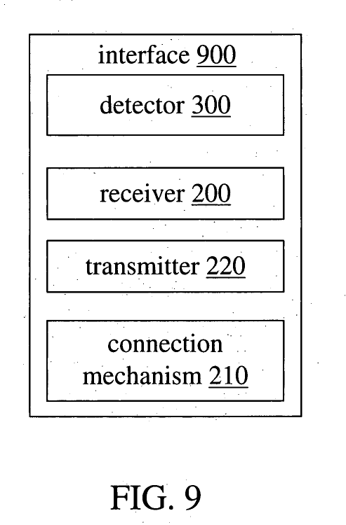

FIG. 9 shows an interface 900 according to an embodiment of the invention. Interface 900 may be employed as an interface to a synchronous bus (e.g. a shared TDM bus for voice calls). For example, interface 900 may be associated with the PON side or the PSTN side of a voice call. Interface 900 includes a detector 300, a receiver 200, and a connection mechanism 210.

Detector 300 detects a call status (e.g. presence of a call and/or a termination of a call). Detector 300 may also detect other call information such as an indication of the desired destination for the call (e.g. a voice circuit). Transmitter 220 transmits the detected information to, e.g., a control device such as controller 800 (for example, as a call setup or teardown request). In some implementations, the information is transmitted via an OAM channel. Receiver 200 receives an indication of an allocated timeslot of a synchronous (e.g. TDM) bus (for example, from a control device, possibly via an OAM channel). Connection mechanism 210 (e.g. a programmable cross-connect device) connects to the synchronous bus in accordance with the received indication. Connection mechanism 210 also may disconnect from the synchronous bus (or otherwise release the allocated timeslot(s)) based on the detected termination of the call and/or the occurrence of another event or condition, such as receipt of an indication from a control module (e.g. via an OAM channel). In another embodiment, connection mechanism 210 also performs signaling monitoring operations.

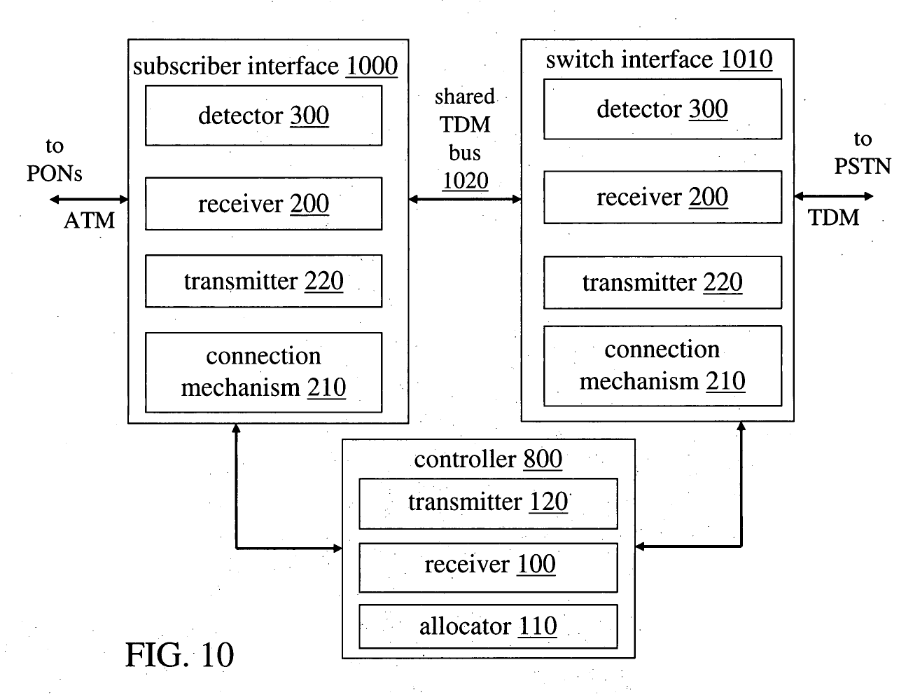

FIG. 10 shows a system according to an embodiment of the invention. The system includes a PON interface 1000, a switch interface 1010, and a controller 800.

PON interface 1000 is an interface between shared TDM bus 1020 and one or more PONs utilizing ATM protocols for voice calls. PON interface 1000 includes a detector 300, a transmitter 220, a receiver 200, and a connection mechanism 210. PON interface 1000 is an implementation of interface 900 of FIG. 9 and may be embodied as or within a card or card assembly inserted into a backplane. The system may also include other instances of PON interface 1000 configured to connect other PONs to the shared bus.

Switch interface 1010 is an interface between shared TDM bus 1020 and a PSTN utilizing TDM protocols for voice calls. Switch interface 1010 includes a detector 300, a transmitter 220, a receiver 200, and a connection mechanism 210. Switch interface 1010 is an implementation of interface 900 of FIG. 9 and may be embodied as or within a card or card assembly inserted into a backplane. The system may include multiple instances of switch interface 1010.

Controller 800 allocates timeslots of shared TDM bus 1020 for voice calls and directs usage of such timeslots by PON interface 1000 and switch interface 1010 in order that voice calls may be transferred between the PON(s) and the PSTN. Controller 800 includes a receiver 100, an allocator 1110, and a transmitter 120 and may be embodied as or within a card or card assembly inserted into a backplane.

In an example scenario, a call arrives at either the PON side or PSTN side with respect to shared TDM bus 1020. Assuming, for illustrative purposes, that the call is originated at the PON side, then detector 300 in subscriber interface 300 detects the call. Subscriber interface 1000 transmits an indication thereof (e.g. a call setup request, possibly via an OAM channel) to controller 800, which indication is received by receiver 100. Allocator 110 of controller 800 allocates one or more timeslots of shared TDM bus 1020 to the call. Transmitter 120 transmits an indication thereof to both subscriber interface 1000 and switch interface 1010 (e.g. via OAM channels), whose respective receivers 200 receive such indication. Their respective connection mechanisms 210 connect to shared TDM bus 1020 in accordance with the indication. As such, a call is established over shared TDM bus 1020.

One or both of the respective detectors 300 of subscriber interface 1000 and switch interface 1010 detect a termination of the call. Subscriber interface 1000 and/or switch interface 1010 respectively transmit an indication thereof (e.g. a call teardown request, possibly via an OAM channel) to controller 800. In response, transmitter 120 of controller 800 may transmit an indication (e.g. via OAM channels) that subscriber interface 1000 and switch interface 1010 should disconnect from shared TDM bus 1020 (or otherwise release the timeslot(s) associated with the terminated call) to free the bus resources. After receipt of the indication by the respective receivers 200, the respective connection mechanisms 210 disconnect from the shared TDM bus 1020 (release the associated timeslot(s)).

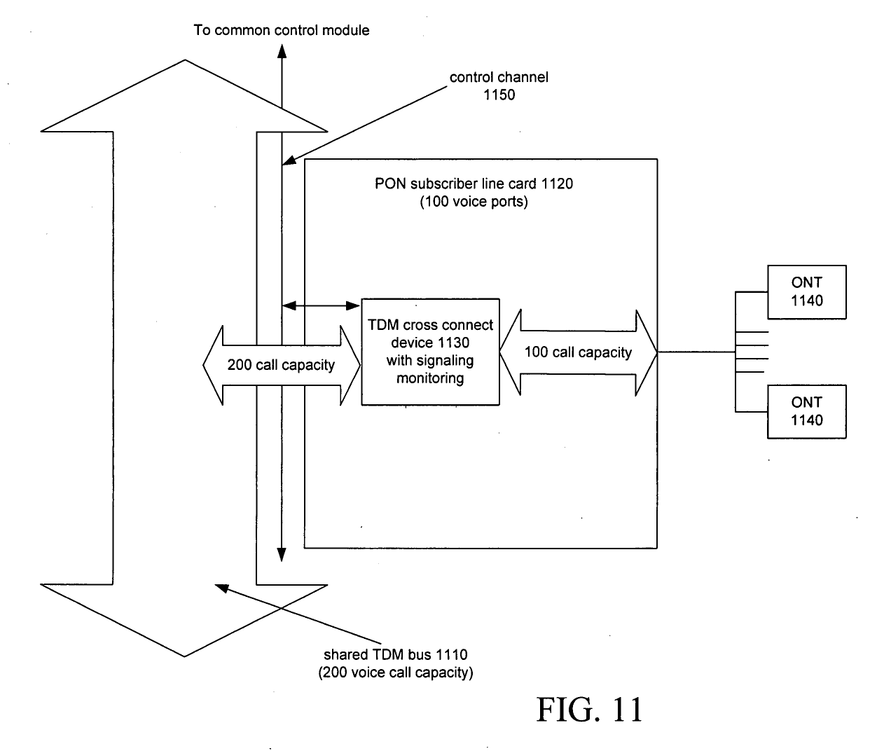

FIG. 11 shows another architecture for concentrating ATM signals onto a TDM bus according to an embodiment of the invention. The architecture includes a shared TDM bus 1110 to transport active calls, a PON subscriber line card 1120 with a TDM cross connect device 1130; a control channel 1150, and one or more ONTs 1140. It is to be appreciated that the call capacities and voice port specifications identified in FIG. 111 and discussed below are merely exemplary and are not limiting. Moreover, ONTs 1140 may be replaced with other types of ONUs.

PON subscriber line card 1120 includes 100 voice ports and has the requisite bandwidth to service 100 ATM-based voice calls passing through ONTs 1140. TDM cross-connect device 1130 is configured to couple PON subscriber line card 1120 to shared TDM bus 1110 in order to utilize allocated timeslots of shared TDM bus 1110. In the example of FIG. 11, TDM cross-connect device 1130 and shared TDM bus 1110 have a 200-call capacity. In addition, TDM cross-connect device 1130 has signaling monitoring capabilities. Accordingly, TDM cross-connect device 1130 can detect a call that is to be established between an ONT 1140 and another endpoint, such as another ONU within a PON or an endpoint in an external TDM-based network (e.g. PSTN), and transmit an indication (e.g. a call setup request) to a common control module (not shown) over control channel 1150 (e.g. via an OAM channel).

In a representative mode of operation, TDM cross-connect device 1130 detects a call and transmits a notification, via control channel 1150, to the common control module. The common control module allocates one or more appropriate timeslots of shared TDM bus 1110 to the call and transmits, via control channel 1150, an indication of the allocated timeslot(s) to TDM cross-connect device 1130. TDM cross-connect device 1130 then appropriately couples PON subscriber line card 1120 to shared TDM bus 1110 so that the call may be established. Thus TDM cross-connect device 1130 is configured to concentrate active voice calls onto the shared TDM bus 1110.

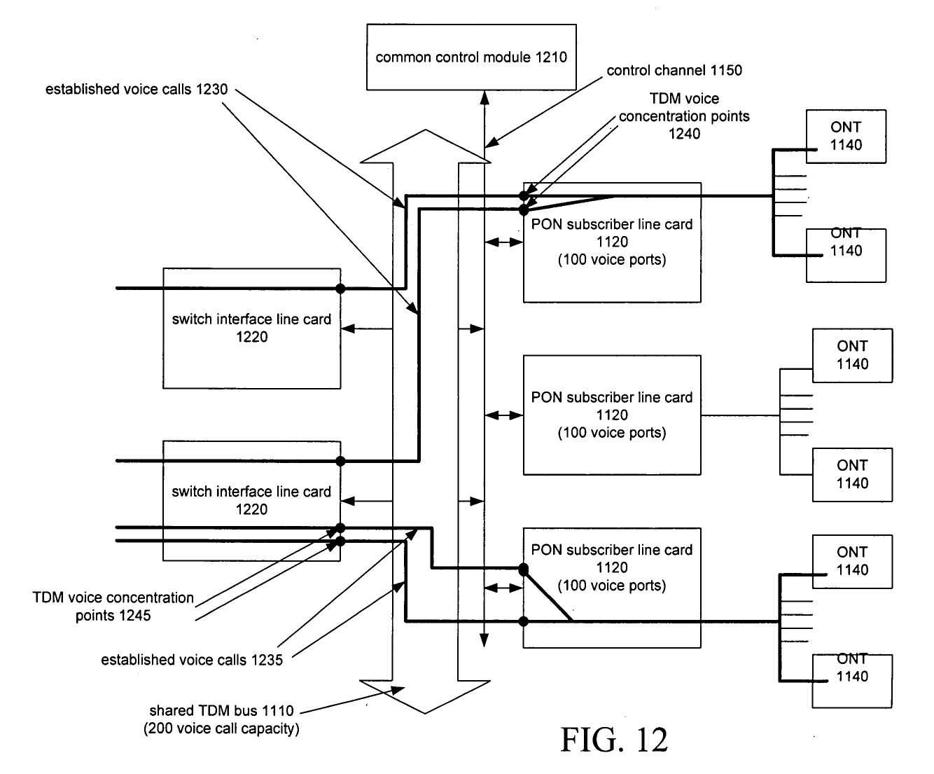

FIG. 12 shows a network including an OAN according to an embodiment of the invention. The OLT system may be employed to concentrate voice signals carried between an external circuit-switched (TDM-based) network and a (ATM-based) PON onto a shared TDM bus. In the system of FIG. 12, ATM signals from the PON are concentrated onto a TDM bus. Similarly, TDM signals from the circuit-switched network are carried over the TDM bus. The system includes a shared TDM bus 1110, switch interface line cards 1220, PON subscriber line cards 1120, a common control module 1210, a control channel 1150, and ONTs 1140. The call capacities and voice port specifications identified in FIG. 12 and discussed below are merely exemplary and are not limiting. Further, ONTs 1140 may be replaced with other types of ONUs.

In this example, PON subscriber line cards 1120 each include 100 voice ports and have the requisite bandwidth to service 100 ATM-based voice calls that involve ONTs 1140. PON subscriber line cards 1120 and switch interface line cards 1220 each can connect to shared TDM bus 1110 in order to utilize allocated timeslots of shared TDM bus 1110. Shared TDM bus 1110 has a 200-voice-call capacity in the example of FIG. 12. Control channel 1150 is coupled to each PON subscriber line card 1120 and switch interface line card 1220, as well as to common control module 1210.

In an example scenario, common control module 1210 allocates one or more appropriate timeslots of shared TDM bus 1110 to a detected call and transmits, via control channel 1150 (e.g. over OAM channels), an indication of the allocated timeslot(s) to the appropriate switch interface line card 1220 and PON subscriber line card 1120. The call is established when the cards 1220 and 1120 connect to shared TDM bus 1110.

Two pairs of established voice calls 1230, 1235 are shown in FIG. 12. For calls 1230, TDM voice concentration points 1240 at a PON subscriber line card 1120 are identified. For established voice calls 1235, TDM voice concentration points 1245 at a switch interface line card 1220 are identified.

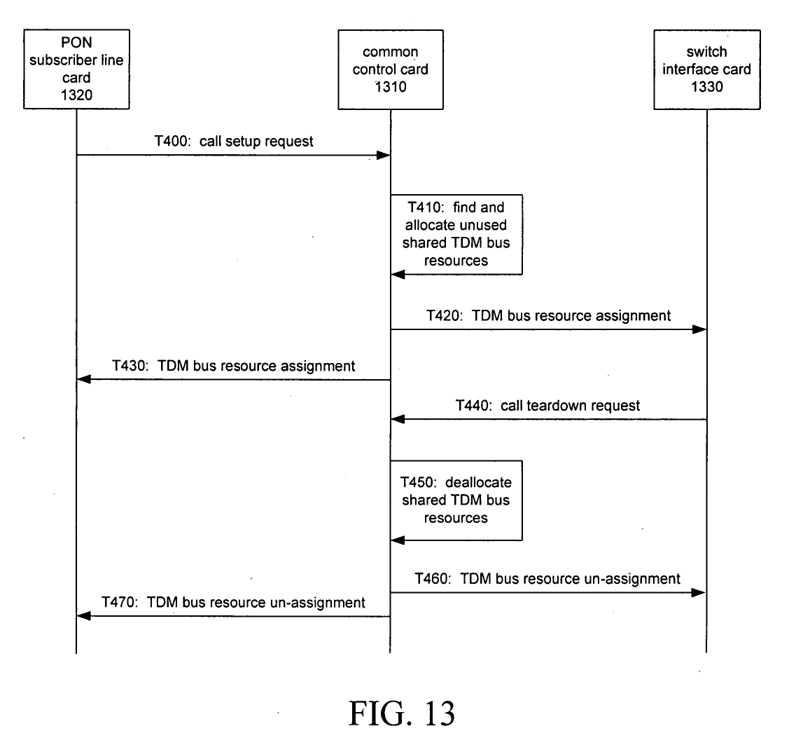

FIG. 13 shows one example of a sequence of interactions between a subscriber line card 1320, a common control card 1310, and a switch interface card 1330 according to an embodiment of the invention. At PON subscriber line card 1320, task T400 transmits a call setup request to common control card 1310. Task T410 finds and allocates unused resources (e.g. timeslots) of a shared TDM bus. Tasks T420 and T430 respectively transmit TDM bus resource assignments to switch interface card 1330 and PON subscriber line card 1320. The call is established when the cards 1330 and 1320 connect to the shared TDM bus. When the call is completed, task T440 at switch interface card 1330 may transmit a call teardown request to common control card 1310. Task T450 at common control card 1310 deallocates the shared TDM bus resources. Tasks T460 and T470 respectively transmit TDM bus resource un-assignments to switch interface card 1330 and PON subscriber line card 1320. The resources of the shared TDM bus are freed for future use when the cards 1330 and 1320 disconnect from the shared TDM bus.

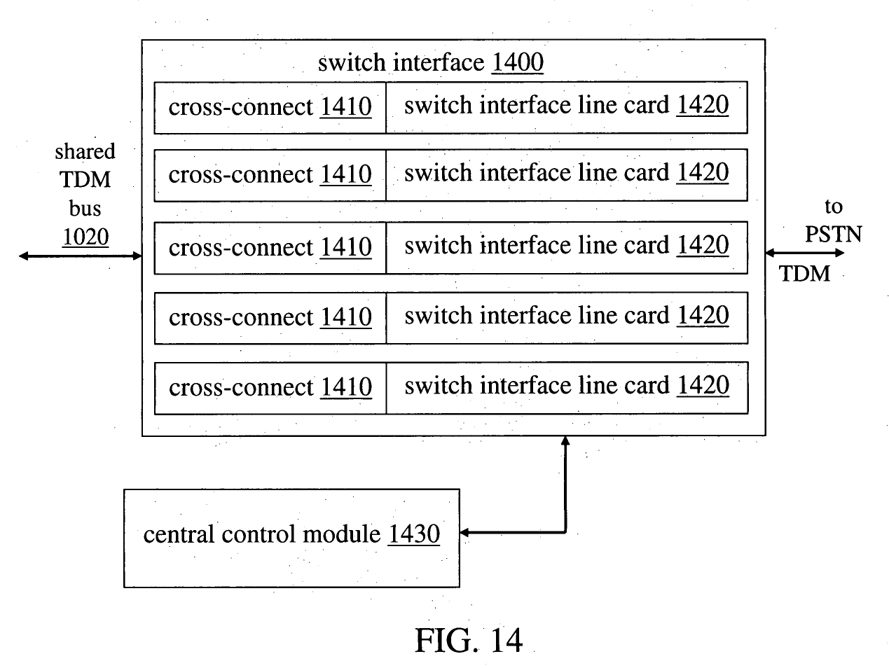

FIG. 14 shows an implementation of a switch interface 1400 according to an embodiment of the invention. Switch interface 1400 includes one or more switch interface line cards 1420 configured to interface with an external circuit-switched network (e.g. a PSTN). Each card 1420 may have an associated cross-connect device 1410 (e.g. a programmable TDM cross-connect device) that interfaces one of a plurality of channels at one side of the device (e.g. lines to the external network) to a selected one of a plurality of channels on the other side of the device (e.g. timeslots of a shared TDM bus 1020). In some embodiments, a cross-connect device 1410 is a programmable module within a card 1420. In other embodiments, a cross-connect device 1410 is a separate programmable device that interfaces with a card 1420. A cross-connect device 1410 may also perform signaling monitoring operations (e.g. to support transmission of call set up and/or teardown requests). The cards 1420 and/or cross-connect devices 1410 interact with a central control module 1430. For each call detected at a subscriber interface side, control device 1430 may transmit a timeslot allocation to a selected one of the switch interface line cards based on, e.g., a load balancing algorithm. Embodiments of the invention may also be implemented to include one or more standard switch interfaces such as TR-57, TR-08, GR-303, and V5.

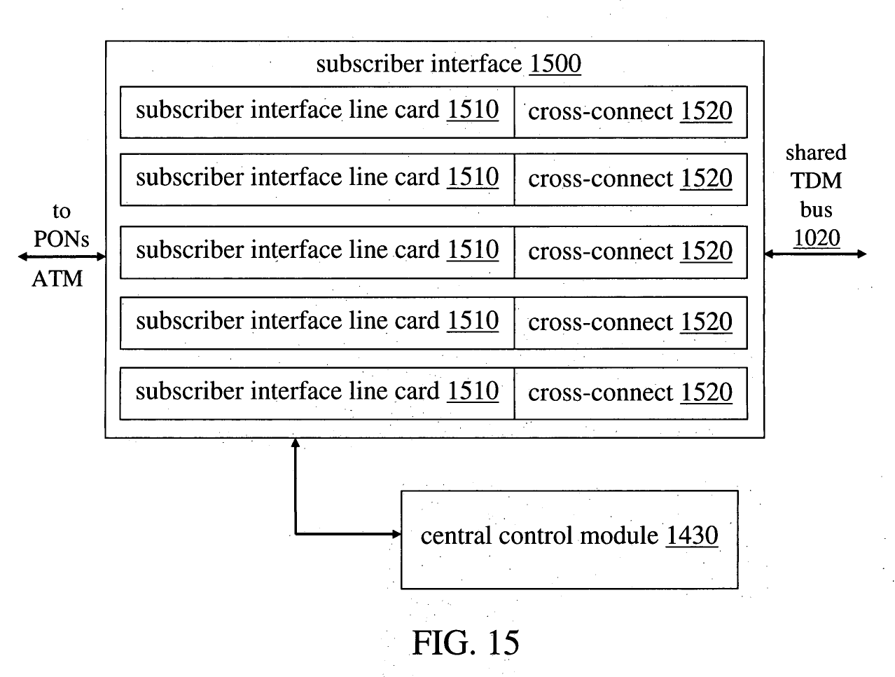

FIG. 15 shows an implementation of a subscriber interface 1500 according to an embodiment of the invention. Subscriber interface 1500 includes one or more subscriber interface line cards 1510. For example, each card 1510 may be associated with a respective PON. Each card 1510 may have an associated cross-connect device 1520 that is configured to interface one of a plurality of channels at one side of the device (e.g. voice ports) to a selected one of a plurality of channels on the other side of the device (e.g. timeslots of a shared TDM bus 1020). In some embodiments, a cross-connect device 1520 is a programmable module integrated into a card 1510. In other embodiments, a cross-connect device 1520 is a programmable device that interfaces with a card 1510. The cards 1510 and/or cross-connect devices 1520 may interact with a central control module 1430 (e.g. via respective OAM channels).

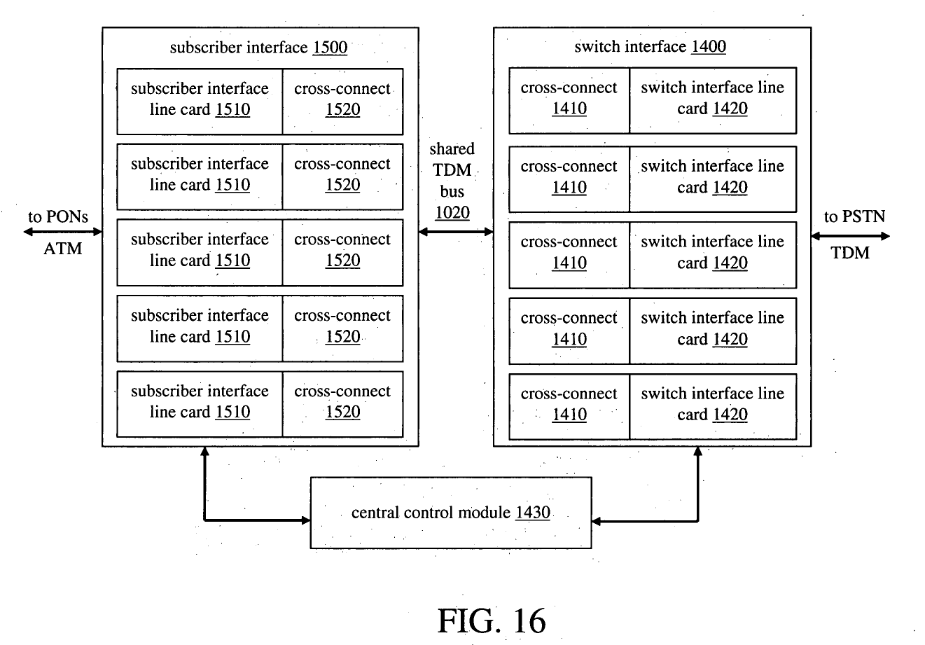

FIG. 16 shows a system according to an embodiment of the invention. The system includes a subscriber interface 1500 as shown in FIG. 15, a switch interface 1400 as shown in FIG. 14, and a central control module 1430. Interactions among these components may be as described in connection with the examples of FIGS. 10-15.

Certain embodiments herein illustrate interactions between a central control module, a subscriber interface including subscriber interface line cards, and a switch interface including switch interface line cards. It is to be appreciated that, in practice, the actual number of such cards in an implementation is arbitrary, depending on the number of PONs utilizing the shared TDM bus, the capabilities of the cards, and/or the number of served subscriber lines, for example.

It is expressly contemplated that alternative operations and/or configurations of such elements, and that apparatus including additional elements, are disclosed by and may be constructed according to the description provided herein. For instance, the subscriber interface line cards and/or switch interface line cards of FIGS. 11-16 may be implemented by hardware and/or software not contained in a card, or in another equivalent fashion as is or may become known in the art of circuit design. In addition, various system components herein may interface discrete modules that perform respective functions. Alternatively or additionally, system components may utilize integrated modules that perform multiple functions.

The foregoing presentation of the described embodiments is provided to enable any person skilled in the art to make or use the present invention. While specific embodiments of the invention have been described above, it will be appreciated that the invention as claimed may be practiced otherwise than as described. Various modifications to these embodiments are possible, and the generic principles presented herein may be applied to other embodiments as well.

An embodiment of the invention may be implemented in part or in whole as a hard-wired circuit (e.g. implemented on a computer interface card) and/or as a circuit configuration fabricated into one or more arrays of logic elements arranged sequentially and/or combinatorially and possibly clocked (e.g. one or more integrated circuits (e.g. ASIC(s)) or FPGAs). Likewise, an embodiment of the invention may be implemented in part or in whole as a firmware program loaded or fabricated into non-volatile storage (such as read-only memory or flash memory) as machine-readable code, such code being instructions executable by an array of logic elements such as a microprocessor or other digital signal processing unit.

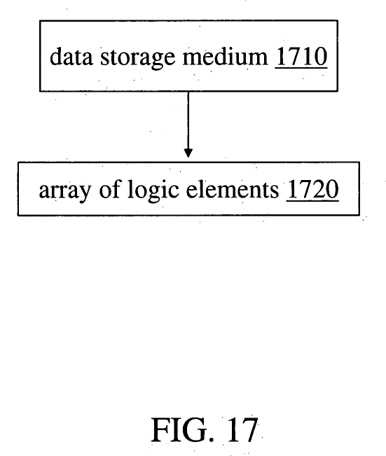

Further, an embodiment of the invention may be implemented in part or in whole as a software program loaded as machine-readable code from or into a data storage medium (e.g., as shown in FIG. 17) such as a magnetic, optical, magnetooptical, or phase-change disk or disk drive; or some form of a semiconductor memory such as ROM, RAM, or flash RAM, such code being instructions (e.g. one or more sequences) executable by an array of logic elements such as a microprocessor or other digital signal processing unit, which may be embedded into a larger device. Thus, the present invention is not intended to be limited to the embodiments shown above but rather is to be accorded the widest scope consistent with the principles and novel features disclosed in any fashion herein.

What is claimed is:

1. A method of voice signal concentration, said method comprising:
receiving idle traffic via each of a plurality of voice ports;
receiving active traffic via at least one of the plurality of voice ports, while continuing to receive idle traffic via the remainder of the plurality of voice ports; and
concentrating the active traffic received via at least one of the plurality of voice ports onto a shared bus.

2. The method of voice signal concentration according to claim 1, wherein the shared bus is a synchronous bus.

3. The method of voice signal concentration according to claim 1, wherein the shared bus is a time-division-multiplexed bus.

4. The method of voice signal concentration according to claim 1, wherein said receiving idle traffic includes terminating at least one asynchronous transfer mode network via said plurality of voice ports.

5. The method of voice signal concentration according to claim 1, wherein said receiving idle traffic includes receiving asynchronous transfer mode cells carrying said idle traffic.

6. The method of voice signal concentration according to claim 1, wherein said receiving active traffic includes receiving asynchronous transfer mode cells carrying said active traffic.

7. The method of voice signal concentration according to claim 1, wherein said receiving active traffic includes receiving partially filled asynchronous transfer mode cells carrying said active traffic.

8. The method of voice signal concentration according to claim 1, wherein said receiving idle traffic includes receiving idle traffic via at least one passive optical network.

9. The method of voice signal concentration according to claim 1, wherein said receiving idle traffic includes receiving idle traffic, via each of the plurality of voice ports, from a corresponding optical networking unit.

10. The method of voice signal concentration according to claim 1, said method comprising carrying information based on a voice signal from the shared bus to at least one of the plurality of voice ports.

11. The method of voice signal concentration according to claim 1, said method comprising transmitting at least one call setup request based on said receiving active traffic.

12. The method of voice signal concentration according to claim 1, said method comprising receiving an allocation of resources of the shared bus, wherein said concentrating includes transferring a voice signal based on said active traffic onto the shared bus according to the allocation.

13. The method of voice signal concentration according to claim 1, wherein said allocation specifies at least one timeslot of the shared bus.

14. A data storage medium having machine-readable instructions, said instructions describing the method of voice signal concentration according to claim 1.

15. A method of voice signal concentration, said method comprising:
receiving active traffic via each of a first voice port and a second voice port;
receiving a first allocation of resources of a shared bus and a second allocation of resources of the shared bus; and
concentrating the active traffic received via the first voice port onto the shared bus according to the first allocation, and concentrating the active traffic received via the second voice port onto the shared bus according to the second allocation,
wherein at least one of the group consisting of the active traffic received via the first voice port and the active traffic received via the second voice port consists essentially of partially filled cells.

16. The method of voice signal concentration according to claim 15, wherein the shared bus is a synchronous bus.

17. The method of voice signal concentration according to claim 15, wherein the shared bus is a time-division-multiplexed bus.

18. The method of voice signal concentration according to claim 15, wherein said receiving active traffic includes terminating at least one asynchronous transfer mode network via said plurality of voice ports.

19. The method of voice signal concentration according to claim 15, wherein said receiving active traffic includes receiving asynchronous transfer mode cells carrying said active traffic.

20. The method of voice signal concentration according to claim 15, wherein said receiving active traffic includes receiving active traffic via at least one passive optical network.

21. The method of voice signal concentration according to claim 15, wherein said receiving active traffic includes receiving active traffic, via at least one of said voice ports, from a corresponding optical networking unit.

22. The method of voice signal concentration according to claim 15, said method comprising carrying information based on a voice signal from the shared bus to at least one of said voice ports.

23. The method of voice signal concentration according to claim 15, said method comprising transmitting at least one call setup request based on said receiving active traffic.

24. The method of voice signal concentration according to claim 15, wherein said first allocation specifies at least one timeslot of the shared bus, and wherein said second allocation specifies at least one other timeslot of the shared bus.

25. A data storage medium having machine-readable instructions, said instructions describing the method of voice signal concentration according to claim 15.

26. A communications apparatus comprising:
a shared bus; and
a cross-connect device configured to receive idle traffic via each of a plurality of voice ports,
wherein the cross-connect device is configured to transfer, onto an allocated portion of the shared bus, a voice signal based on active traffic received via one of the plurality of voice ports.

27. The communications apparatus according to claim 26, wherein the shared bus is a synchronous bus.

28. The communications apparatus according to claim 26, wherein the shared bus is a time-division-multiplexed bus.

29. The communications apparatus according to claim 26, wherein said apparatus is configured to terminate at least one asynchronous transfer mode network via said plurality of voice ports.

30. The communications apparatus according to claim 26, wherein said apparatus is configured to receive asynchronous transfer mode cells carrying said idle traffic.

31. The communications apparatus according to claim 26, wherein said apparatus is configured to receive asynchronous transfer mode cells carrying said active traffic.

32. The communications apparatus according to claim 26, wherein said apparatus is configured to receive partially filled asynchronous transfer mode cells carrying said active traffic.

33. The communications apparatus according to claim 26, wherein said apparatus is configured to receive said idle traffic via at least one passive optical network.

34. The communications apparatus according to claim 26, wherein said apparatus is configured to receive idle traffic, via each of the plurality of voice ports, from a corresponding optical networking unit.

35. The communications apparatus according to claim 26, wherein said apparatus is configured to carry information based on a voice signal from the shared bus to one of the plurality of voice ports.

36. The communications apparatus according to claim 26, wherein said apparatus is configured to transmit at least one call setup request based on said voice signal.

37. The communications apparatus according to claim 26, wherein said apparatus is configured to receive an allocation of resources of the shared bus and to transfer the voice signal onto the shared bus according to the allocation.

38. The communications apparatus according to claim 37, wherein said allocation specifies at least one timeslot of the shared bus.

39. The communications apparatus according to claim 27, said apparatus comprising an interface between the shared bus and a public switched telephone network.

40. An apparatus comprising:
a shared bus; and
a cross-connect device configured to receive active traffic via each of a first voice port and a second voice port,
wherein the cross-connect device is configured to transfer, onto a first allocated portion of the shared bus, a voice signal based on active traffic received via the first voice port, and
wherein the cross-connect device is configured to transfer, onto a second allocated portion of the shared bus different from the first allocated portion, a voice signal based on active traffic received via the second voice port, and
wherein at least one of the group consisting of the active traffic received via the first voice port and the active traffic received via the second voice port consists essentially of partially filled cells.

41. The communications apparatus according to claim 40, wherein the shared bus is a time-division-multiplexed bus.

42. The communications apparatus according to claim 40, wherein said apparatus is configured to terminate at least one asynchronous transfer mode network via said voice ports.

43. The communications apparatus according to claim 40, wherein said apparatus is configured to receive asynchronous transfer mode cells carrying said active traffic.

44. The communications apparatus according to claim 40, wherein said apparatus is configured to receive said active traffic via at least one passive optical network.

45. The communications apparatus according to claim 40, wherein said apparatus is configured to receive said active traffic, via each of said voice ports, from a corresponding optical networking unit.

46. The communications apparatus according to claim 40, wherein said apparatus is configured to carry information based on a voice signal from the shared bus to at least one of said voice ports.

47. The communications apparatus according to claim 40, wherein said apparatus is configured to transmit at least one call setup request based on said voice signal.

48. The communications apparatus according to claim 40, wherein said first allocation specifies at least one timeslot of the shared bus, and wherein said second allocation specifies at least one other timeslot of the shared bus.

49. The communications apparatus according to claim 40, said apparatus comprising an interface between the shared bus and a public switched telephone network.
